(19) United States
(12) Patent Application Publication
(10) Pub. No.: US 2004/0045401 A1
(43) Pub. Date: Mar. 11, 2004

(54) Pedal traction system using independent crank arms with no dead point

(76) Inventor: Pablo Vergara Carrasco, Ajalvir, Madrid (ES)

Correspondence Address: Marguerite Del Valle, Trademark & Patent Counselors of America, 19th Floor, 915 Broadway, New York, NY, 10010, US

(21) Appl. No.: 10/398,468

(22) PCT Filed: Jan. 2, 2001
(86) PCT No.: PCT/ES01/00001

(30) Foreign Application Priority Data
Oct. 3, 2000 (ES) P 200002379

(51) Int. Cl. G05G 1/14

(52) U.S. Cl. 74/594.3

(57) ABSTRACT

The invention relates to a pedaling system using independent crank arms, a power plate—which rotates about an axis at a distance from and parallel to the axis of the bottom bracket—that is mounted by means of bearings on an eccentric support that can be fixed to the casing of the bottom bracket, and a transfer arm which is integral with the crank arm opposite to the side of the plates by means of an axle of the bottom bracket. Torque is thus transmitted from the crank arm on the side of the plates and from the transfer arm by means of two pushers that are connected to points diametrically opposite to the plate. During pedaling, relative development gradually increases as each pedal descends and the bicycle gains inertia. When the pedal is approaching the end of its descending phase and the tangential component of the force being applied decreases, the torque load decreases more rapidly.

The present invention refers to a pedal system mainly applicable to bicycles.

It is a mechanism of independent crank arms which replace the conventional bottom bracket and crank arms with sprocket wheels to achieve optimised kinematics for pedalling, so that each crank arm moves more slowly during the downward phase than during the upward phase, with the result that both crank arms never coincide at the pedalling dead point, one at the bottom and the other at the top. This kinematic chain means that the torque required of the legs during the pedal downward phase, when the knee extends, is greater than during the upward phase, when the knee bends, which matches up with the thrust potential of the leg muscles.

### Prior Art

From their early beginning up to the present day practically all bicycles make use of aligned opposing crank arms which move one or more round sprocket wheels centred on the pedal shaft. In this way the pedals describe circumferences on parallel planes, these always being at diametrically opposed points on said circumferences and moving at a constant speed for a constant speed of the bicycle. It is known however that this kinematic chain is not the most appropriate, especially on account of the existence of a pedalling dead point, which has led to numerous attempts to eliminate this dead point, firstly by the use of oval sprocket wheels and later by means of independent crank arms with variable speed and development.

Oval sprocket wheels reduce the dead point effect by making the speed at which the pedals pass though it faster. This kinematic train, however, has collateral effects corresponding to leg movement acceleration and deceleration, which is detrimental, and this is why they have disappeared from the market.

With regard to independent crank arm systems with variable speed and development, there are various mechanisms that achieve this kinematic chain. One possible is to use two pairs of elliptical gears as in U.S. Pat. No. 5,899,477 and application PCT/ES00/00098 pertaining to the same as the present one: while one pair of gears, offset 180° from each other, rotates at a constant speed, the second pair, which engages with the former and which matches up with two crank arms, varies its speed alternately according to a sine function. Another possibility, put forward in U.S. Pat. Nos. 4,816,009 and 5,067,370, is by means of a power plate which rotates about an axis parallel to and at a distance from the bottom bracket, a plate which is driven by the crank arms—which rotate around the axis of the bottom bracket —by means of pullers anchored at diametrically opposed points of the power plate: in this way, when the plate rotates at constant speed the crank arms will go on varying their speed—and therefore their relative development or drive ratio—due to the offsetting of the aforesaid plate, which causes the effective lever arm to vary as it rotates; in this case the speed and relative development functions—or torque load—for the crank arms, shown in FIG. 1, correspond to sine waves deformed laterally towards sawteeth due to the effect of the pullers. This U.S. Pat. No. 4,816,009 also contains a version of this mechanism in which the crank arms move the aforesaid offset power plate by way of pins which move along two diametrically opposed slots made in this plate; in this case the variation in speed for the crank arms corresponds to a sine function.

As regards U.S. Pat. No. 5,899,477 and the aforesaid application PCT/ES00/00098—in which the four gears are housed in the frame in a special bottom bracket housing—it is a mechanism that has proved the efficiency of the kinematic chain proposed and which has succeeded in gaining a foothold in the market. Insofar as biomechanics are concerned, higher levels of pedalling power and consistency are achieved with lower cardiovascular effort and less knee joint fatigue. However, with regard to market potential, this is limited by the need to use a specific bicycle frame, which represents an obstacle for bicycle manufacturers, who would have to alter their production process, and for consumers, who have to change bicycle.

As regards the power plate system of U.S. Pat. No. 4,816,009, already expired, we will examine 2 versions that include:

With regard to the versions with slots machined in the power plate and sinusoidal speed variation, the biomechanical advantages are the same as those mentioned above; it is an unreliable mechanism, however, due to the friction, poor lubrication and impossibility of keeping the aforesaid slots clean.

As regards the version corresponding to the above-mentioned pullers, these reliability problems are practically eradicated in spite of being a more complex mechanism; nevertheless, there are two major drawbacks:

i. Structural problem: This patent describes and claims a mechanism in which the bottom bracket is made up of two coaxial shafts, one for each crank arm, and from which two extensions or arms extend wherefrom the power is transmitted to the power plate by means of respective pullers. Bearing in mind that it is a mechanism designed for installation in a standard bottom bracket housing of the appropriate size needed to house a single shaft, the structural problem of having to integrate two coaxial shafts and their respective bearings is practically unsurmountable. In addition, on the plate side there would have to be enough room not only for the power plate and the part supporting it—by way of a bearing—offset in relation to the bottom bracket, but also for the aforesaid shaft extensions and for one of the crank arms; and this would involve having to increase the space between the pedals, which would be quite inadvisable for the legs, as they would have to be wider apart.

ii. Biomechanical problem: in this case it is a problem intrinsic to the puller system, as in order to achieve a significant improvement that justifies the complication of the system in relation to the conventional pedalling system by means of a system of independent crank arms of variable development, the variation in speed of the crank arms also has to be significant, which means that the afore-mentioned sawtooth effect in the speed functions and torque load take on increasing importance: as the crank arms approach their maximum torque position they undergo strong deceleration, whereas, once past this point, the acceleration taking place in the crank arms is more gradual, as shown in FIG. 1, where the starting point of the cycle is taken to be at top dead centre (TDC). This effect is what takes place during the pedal downward phase, i.e. since the bicycle has to be accelerated again at every pedal stroke, as this goes on regaining speed, the relative development—or torque load—of the pedal when it descends from top dead centre may go on gradually building up, and later, as the pedal approaches the end of its downward phase and the tangential component of the force applied decreases rapidly, and therefore the possibility of exerting effective force—this is when the torque load may drop more quickly. This is the case that is shown in FIG. 2, where the starting point of the cycle is taken to be at top dead centre (TDC).

The above-mentioned structural problem is what is solved by U.S. Pat. No. 5,067,370, which claims a solution in which joint use is made of the following items: a) a single shaft which is coupled to the crank arm opposite the plate side—so that the other crank arm is free to rotate in relation to it; b) a support for said shaft in the bottom bracket housing; and c) an eccentric component—in relation to the bottom bracket shaft—carrying the power plate—by way of a bearing. This component is eccentric in order to offset the power plate, and once it is installed on this shaft support, its angular position may be modified in relation to the shaft in order to adjust the direction of said offset, while it is provided with the means necessary to anchor it once it has been adjusted. In this mechanism the plate side crank arm transmits the force to the power plate by means of a puller, whilst the opposite crank arm does so, first of all via the shaft to a transfer arm integral with it, and from there by way of a puller to the aforesaid plate. Thus, not only is the problem of the two coaxial shafts resolved, but also the natural space between pedals is successfully maintained. Said U.S. Pat. No. 5,067,370, however, still does not provide an answer to the above-mentioned biomechanical problem.

Lastly, with regard to the prior art, we should mention the existence of U.S. Pat. No. 6,085,613, although it has been regarded of minor importance since it is basically a particularisation of U.S. Pat. No. 4,816,009, to be specific with regard to the sealing and protection of the bottom bracket housing and its two concentric shafts; and in any case it offers the same afore-mentioned problems—structural and biomechanical.

### SHORT DESCRIPTION OF THE FIGURES

FIG. 1 shows the speed and relative development or load torque curves during a complete cycle for any one of the pedals corresponding to an offset power plate mechanism and pullers. The top dead centre (TDC) position is taken as the starting point of the cycle.

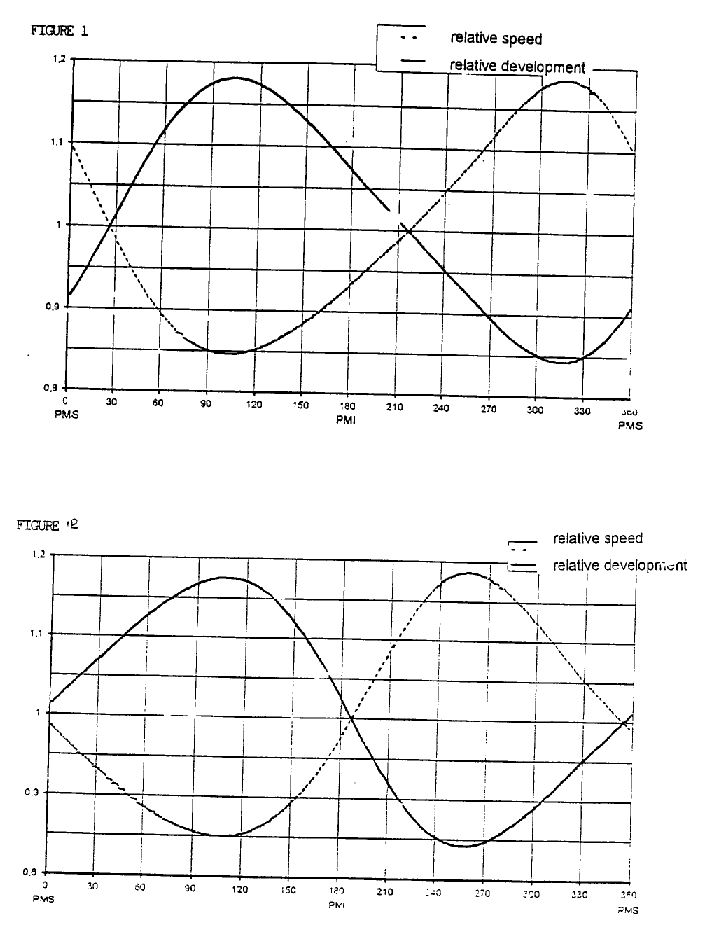

FIG. 2 shows the speed and relative development or load torque curves during a complete cycle for any one of the pedals corresponding to an offset power plate mechanism and pullers. The top dead centre (TDC) position is taken as the starting point of the cycle.

In these two figures we may observe the tendency towards sawteeth mentioned above and that the increase in torque load is more abrupt in the former than in the latter case.

FIG. 3 shows an elevational view of a mechanical configuration referring to the present invention.

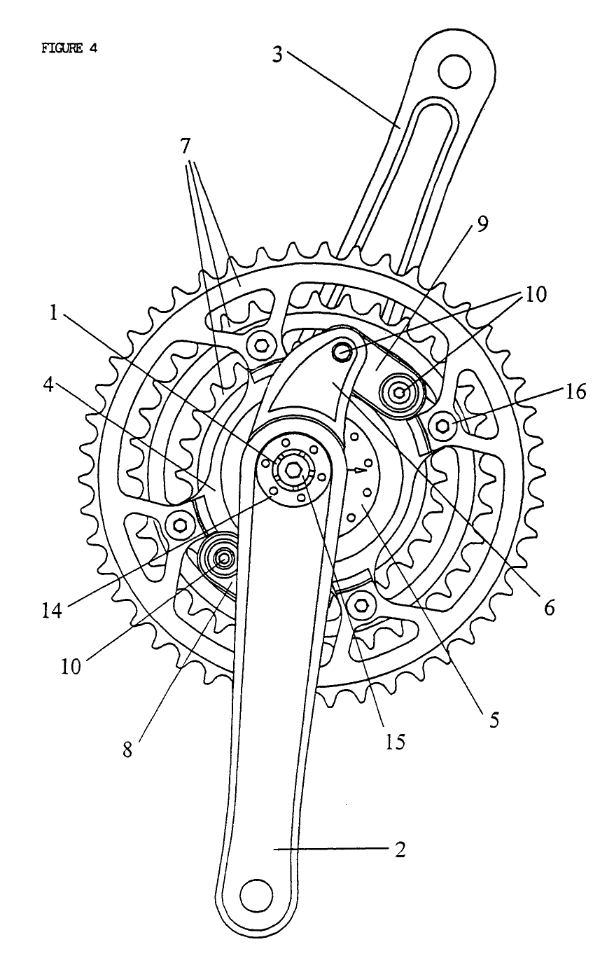

FIGS. 4 and 5 are respective elevational and plan views of a preferred mechanism corresponding to the present invention.

FIGS. 6, 7 and 8 show particular solutions in the aforesaid mechanism, as will be seen later.

### SUMMARY OF THE INVENTION

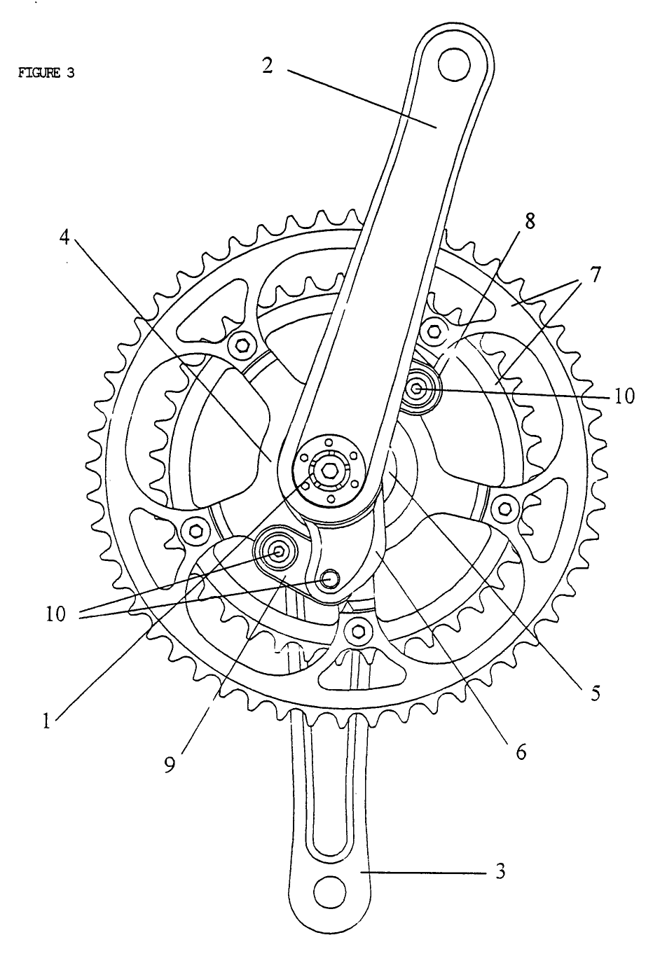

The present mechanism also proposes a mechanism for coupling to the bottom bracket housings of bicycles and the like, based on an offcentred power plate, but which primarily aims to offer a solution to the biomechanical problem described affecting earlier ones. In this case too, use is made of independent crank arms (2 and 3), which rotate about an axis (E1) corresponding to the bottom bracket and capable of having pedals coupled at their ends; of a bottom bracket shaft (1) supporting the aforesaid crank arms; of a power plate (4)—which rotates at its centre around an axis (E2) at a distance from and parallel to the former axis (E1)—which is mounted—free of rotation preferably by means of a bearing (11)—on an eccentric support (5) for attachment to the bicycle bottom bracket housing (0); and of a transfer arm (6) which is integral with the bottom bracket shaft (1) and with the crank arm 3) opposite the power plate (4) side. Naturally, and like the afore-mentioned mechanisms, the power plate (4) may in turn be a carrier of sprocket wheels (7) so as to drive a rear wheel by means of a chain. As in the mechanisms corresponding to U.S. Pat. Nos. 4,816,009 and 5,067,370, the power is transmitted from the plate side crank arm (2) and from the opposite crank arm (3)—via the bottom bracket shaft (1) and the transfer arm (6)—by two links (8 and 9) fixed by means of pins (10) at one of their ends to the crank arm (2) or to the transfer arm (6), respectively, and at the other end to the power plate (4), this pin attachment system for each of the aforesaid parts being at points diametrically opposed to the power plate (4); but in this case, and for the sole purpose of achieving optimised biomechanics, said links take the form of pushers and not pullers, so that every link pin to the power plate always goes ahead of the corresponding link pin to the crank arm or transfer arm, i.e. when an effective torque input takes place from each crank arm, said links will work under compression instead of traction. Far from representing an insignificant difference, the above-mentioned improvement is the outcome of this arrangement, as a kinematic reversal is brought about in respect of a system with pullers, and the result is that the pedals decelerate more gently and accelerate more sharply, according to FIG. 2, with the result that in this way, upon propelling the bicycle at each pedal stroke, as it goes on picking up inertia, the relative development—or torque load—of the pedal, when it descends from top dead centre, may go on gradually increasing, and later, as the pedal reaches the end of its downward phase and the tangential component of the force applied decreases, this is when the torque load drops most rapidly. An improvement is thereby achieved in power delivery as well as greater efficiency for the cyclist's effort, which represents a clear qualitative difference in respect of the prior art.

Naturally, use is made of the necessary means for offering support and protection and safeguarding the parts of the mechanisms, namely the bearings, seals, bolts, nuts, etc.

### DESCRIPTION OF PREFERRED MECHANISMS

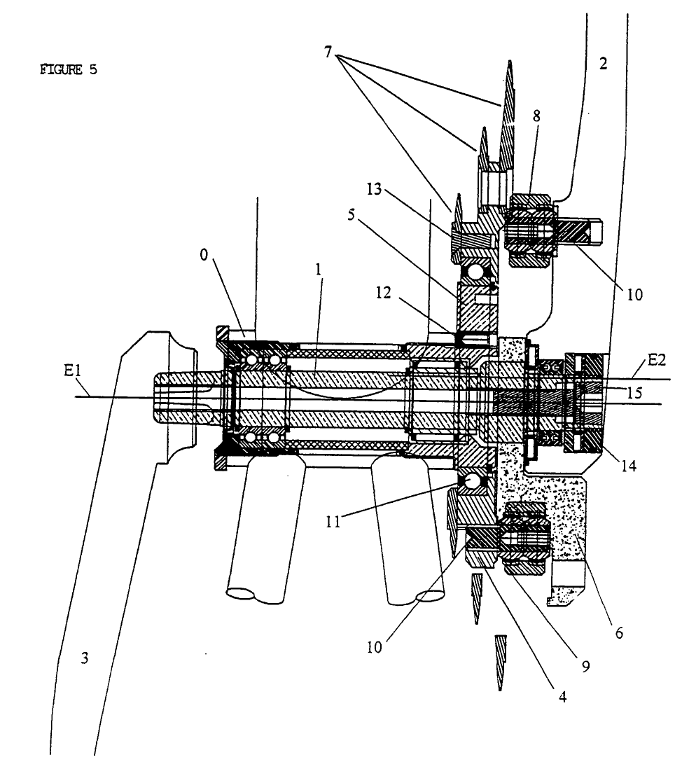

When it comes to the embodiment of the afore-mentioned mechanical configuration, some solutions may be incorporated that will assure the correct working of the system. The resultant mechanism is shown in FIGS. 4 and 5.

Very high loads may eventually be applied on the pedals of a bicycle, either because of heavy application of torque at a given moment or through the cyclist standing on the pedals when being confronted with a step, jump or the like. In this case the mechanical stress on the pins (10) and the bearing (11) that supports the power plate (4) could actually be critical due to the multiplication of the forces represented by the lever ratio between the pedal-bottom bracket and pin-bottom bracket distances. It is therefore necessary for the distance from the pins (10) to the bottom bracket shaft (1) to be as great as possible. Since the force that is transmitted by the links (8 and 9) from the crank arm (2) and from the transfer arm (6) to the power plate has preferably to be in the tangential rotation direction, it is also advantageous for the attachment of the pins to said plate to be at points as far as possible away from its centre (E2). This will also ensure that there is more free space at the centre of the power plate so that it will permit use of a bearing (11) that is larger sized and therefore able to withstand higher loads.

However, there is a limit to the distance between the pins in the power plate, embodied in the two sprocket wheels (7) which it has to couple—when drive is going to be applied by means of a chain with two or three sprocket wheels—as the pins have to respect the space required for the chain on said sprocket wheels, whilst also respecting the arms with which each sprocket wheel is provided for their anchorage to the power plate. As the pins have to be located at diametrically opposed points of the power plate, the ideal configuration for the arms of the sprocket wheels corresponds to an even number, preferably four, so that two symmetrical free spaces are respected which will allow for the movement carried out by the links and pins, at the greatest distance, and the pins and bearings will therefore bear less load. Thus, there is no longer any limit to this distance corresponding to the sprocket wheel arms and which is present in the case of five anchorage points corresponding to standard sprocket wheels. An added advantage through using four-arm sprocket wheels is that, since these arms cease to represent an obstacle for the location of the pins, the anchor points for the sprocket wheels on the power plate may be located at a shorter distance from the centre, and this enables smaller sprocket wheels to be used in the case of the second wheel, which has a diameter that is always limited underneath due to the power plate anchorages.

The arrangement of the links (8 and 9) as pushers brings about a kinematic variation in respect of the pullers which entails the afore-mentioned biomechanical improvement, but at mechanical level it is not just a matter of coupling the connecting components in one way or another: as every pin for connection to the power plate (4) always goes ahead of its own pusher, the anchor points or arms for the sprocket wheels will have to be located ahead of said pins so that the pushers do not collide with these arms.

Since the aim is to make use of a bearing (11) of the largest size that the volume of the system will permit so as to give free rotation support to the power plate, there is a limitation in the event of using three sprocket wheels, as the third wheel, the smallest one, has to have a diameter appreciably larger than that of this bearing. In order to be able to use the smallest sprocket wheel possible, said wheel will have to be located on the inner side of the bearing and be anchored to the power plate not with an anchorage with standard screws (16) as the larger sprocket wheels, but with small screws (13), so that the space required for its anchorage is reduced to a minimum. Besides this fastening of the third sprocket wheel adjacent to the aforesaid bearing, it may be utilised to assure the fixing of this bearing to the power plate.

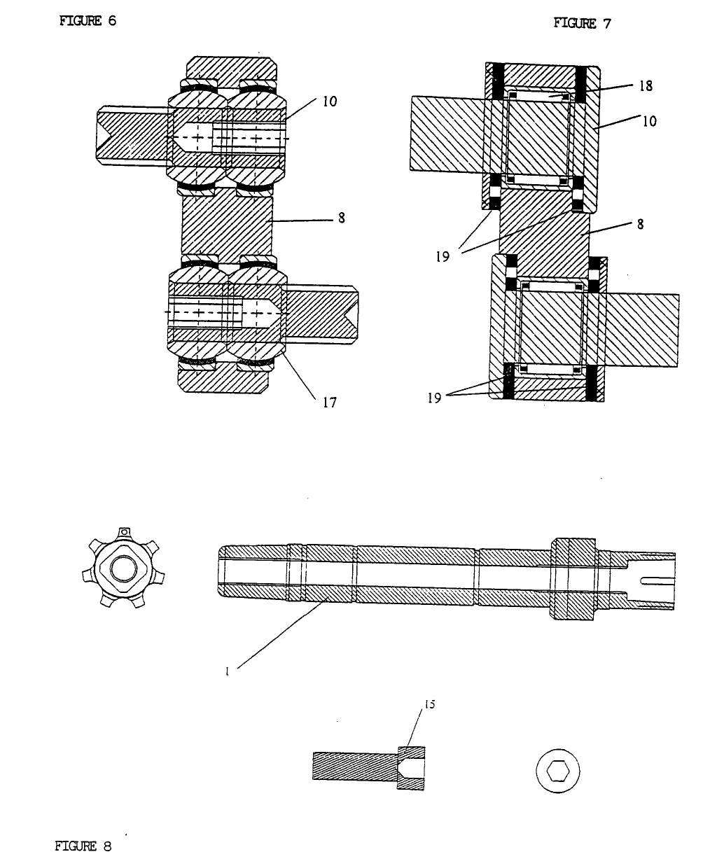

Furthermore, the driving forces transmitted by the links or pushers (8 and 9) are contained in a plane parallel to the one containing the bearing (11) supporting the power plate. This gives rise to a transverse torque on this bearing which may prove detrimental. To lessen this effect, use is made of two ball-joints (17)—or bearings too—aligned in the union of each pin (10) to its link or pusher (FIG. 6). The result of this is to increase the lateral rigidity of the system by creating two rigid bridges: one between the crank arm (2), the link (8) and the power plate (4); and the other between the transfer arm (6), the link or pusher (9), and the power plate (4). Similarly, high lateral rigidity could be achieved by making use of a bearing (18) or friction bush at the union of each pin with its link for radial support, and of a sandwich of axial bearings or antifriction material washers (19) to achieve axial rigidity (FIG. 7).

In respect of the eccentric support (5) carrying the power plate (4)—via bearing (11), which, as has been said, has to be attachable to the bicycle bottom bracket shaft (0), the solution proposed is that it should be the same part as supports the bottom bracket shaft—by means of bearings, which should be eccentric in its external extension towards the plate side. In this way, the support (5) is on the outside of the bottom bracket housing for the power plate (4) and on the inside for the bottom bracket shaft (1). Since this support is a part that may be placed in any angular position in respect of the bottom bracket housing, this eccentric may be positioned to the users liking—so that the kinematics of the system may be advanced or retarded for subsequent anchorage to the bottom bracket housing making joint use of the actual bottom bracket shaft support fastening—based on standard threads cut in bottom bracket housings of bicycles—and optionally, of one or more grub screws (12) housed in the eccentric, which exert pressure on the actual bottom bracket housing and help to strengthen the fastening. A second improvement, not shown in the figures, is that this eccentric is in turn made up of two eccentrics: one which forms part of the bottom bracket support, and a second that encircles the former and which is attachable to it. Thus, as both eccentricities become out of alignment, the value of the overall eccentricity drops; this improvement however is not regarded as a preferred option, due to strength and simplicity, and the option of having different eccentric supports on the market for coupling to the system but with different eccentricities is considered more beneficial.

As regards the plate side crank arm (2), it has to be free to rotate in relation to the bottom bracket shaft (1), yet maintain great lateral rigidity. For this reason It is coupled to this shaft by means of bearings with both radial and axial support. To achieve the axial tightness to assure this rigidity, the solution proposed is to make use of a nut (14) at the end of the shaft—threaded—which has to be lockable to prevent it from working loose. This locking is achieved by means of a slotted bevel housing (FIG. 8 ) at the end of the shaft where, when a bevel head screw (15) is tightened, lateral expansion takes place at this end, with the result that fastening is achieved between the shaft threads and the nut.

Lastly, it should be mentioned that, to achieve optimum biomechanics with regard to sporting performance, there are two fundamental values: a) the ratio of maximum to minimum relative developments, which is directly connected with the minimum angle that is reached between the crank arms; and b) the angular position at which the eccentric support (5) is fixed in relation to the horizontal, which is directly related to the angular position where the maximum torque load point is located. For the former value (a) an optimum value of 1.4±0.07 is proposed, which is equivalent to a minimum angle between crank arms of 161.5°±2.50°. For the latter value (b) an optimum between 15° and 22° is proposed, which is equivalent to a maximum torque position between 9° and 16° below the horizontal.

As the former of these values (a) depends directly on the main dimensions of the system—saving the scale factor, which affects the mechanical capacity of the system—these dimensions are quoted below for what is considered optimum:

| | |
|---|---|
| eccentricity of eccentric support (5): | 7.7 ± 1 mm |
| length of links (8 and 9): | 28.5 ± 2.5 mm |
| distance from bottom bracket shaft (1) to crank | 52 ± 5 mm |
| arm (2) pin (10): | |
| distance from centre (E2) to pin (10) in power plate (4): | 49 ± 5 mm |

It is in these dimensions where the largest scale factor possible has been sought with a view to higher load capacity and the possibility of using standard diameter sprocket wheels.

These wheels and the power plate preferably have four anchor points positioned at a diameter of 114±1 mm.

As for the latter value (b), the support is fixable by the user at the position he so wishes, but it will be provided with guide marks for positioning around the optimum described.

The following are claimed as being of new and own invention:

1) A mechanical pedalling system for coupling to a bottom bracket housing, which comprises:
a bottom bracket shaft (1), with the bearings and support needed for coupling to said bottom bracket housing (0);
two crank arms (2 and 3), one of them (3) integral with said bottom bracket shaft and the other (2) rotating freely in respect of it;
a power plate (4) which rotates at its centre about an axis (E2) at a distance from and parallel to the bottom bracket shaft (1) and which is the carrier of sprocket chain drive wheels;
an eccentric support (5) at one side of the bottom bracket housing (0), being fixable to it, and which is eccentric in relation to the bottom bracket shaft (1), for the purpose of providing support for this free-rotating power plate (4);
a transfer arm (6), which is integral with the crank arm (3) opposite to the side of this plate (4) by way of the aforesaid bottom bracket shaft (1):
two links, the former of them (8) joined by one of its ends to the power plate (4) side crank arm (2) and by the other to said power plate, and the latter link (9), joined by one of its ends to said transfer arm (6) and by the other to the power plate (4), these four joints being by means of a pin (10) and the two pin joints corresponding to the power plate located at diametrically opposed points of said plate;
and which is characterised in that, for the sole purpose of achieving optimised biomechanics, said links are arranged as pushers and not as pullers, so that each connecting pin to the power plate always goes ahead of the corresponding connecting pin to the crank or transfer arm; the outcome of the aforesaid arrangement is the above-mentioned improvement, as a kinematic reversal is achieved in respect of a system with pullers, and the result is that the pedals decelerate slower and drops most abruptly.

2) A mechanical pedalling system according to claim 1, characterised in that the aforesaid power plate (4) is the carrier of sprocket wheels (7) for the purpose of driving a bicycle rear wheel by means of a chain.

3) A mechanical pedalling system according to claim 2, characterised in that the aforesaid power plate (4) is provided with four anchor points for two sprocket wheels (7) which respect two symmetrical free spaces which permit the free play of the links or pushers (8 and 9), so that each of the anchors points of the pins (10) corresponding to the power plate (4) lies behind one of said anchor points.

4) A mechanical pedalling system according to claim 1, characterised in that use is made of two aligned ball-joints (17) at the union of each pin (10) to its link or pusher (8 and 9) for the purpose of providing rigidity to the pin-link joint.

5) A mechanical pedalling system according to claim 1, characterised in that use is made of two aligned bearings at the union of each pin (10) to its link or pusher (8 and 9) for the purpose of providing the pin-link joint with rigidity.

6) A mechanical pedalling system according to claim 1, characterised in that at the union of each pin (10) to its link or pusher (8 and 9), use is made of a sandwich of antifriction material washers (19) for the purpose of providing the pin-link joint with rigidity.

7) A mechanical pedalling system according to claim 1, characterised in that at the union of each pin (10) to its link or pusher (8 and 9), use is made of an axial bearing sandwich for the purpose of providing the pin-link joint with rigidity.

8) A mechanical pedalling system according to claim 1, characterised in that the aforesaid eccentric support (5) is formed of the actual bottom bracket shaft support at its extension towards the outside of the bottom bracket housing (0); it being therefore a part attachable to the bottom bracket housing, which offers support internally to the bottom bracket shaft (1), with its axis (E1) in the bottom bracket housing, and externally to the power plate (4), with its axis (E2) parallel to and at a distance from the bottom bracket.

9) A mechanical pedalling system according to claim 8, characterised in that said eccentric support (5) is threaded to the bottom bracket housing (0) to achieve its fastening, making use of the actual bottom bracket housing threading; since this support is a screw-up part which may be placed at any angular position in relation to the bottom bracket housing, the direction of the eccentricity may be positioned at the user's discretion.

10) A mechanical pedalling system according to claim 9, characterised in that to reinforce its fastening to the bottom bracket housing (0) said eccentric support (5) makes use of one or more grub screws (12) that exert pressure on said bottom bracket housing.

11) A mechanical pedalling system according to claim 9, characterised in that said eccentric support (5) is in turn made up of two eccentrics: one forming part of the bottom bracket support and a second one, encircling the former, which may be fixed in relation to it, so that the relative position between both eccentrics can be altered, whereby the overall eccentricity is variable.

12) A set of eccentric supports (5) according to claim 9, characterised in that it is made up of interchangeable parts with different eccentricities, whereby the kinematics of the system may be varied by making use of the different components of the aforesaid set.

13) A mechanical pedalling system according to claim 2, characterised in that, in order to couple a third sprocket wheel on its inner side, said power plate (4) has threaded holes for fastening with screws (13) and utilises the lateral placement of this wheel for the lateral fastening of the bearing (11) that supports it.

14) A mechanical pedalling system according to claim 1, characterised in that the crank arm (2), which is independent in relation to the bottom bracket shaft (1), is coupled to said shaft by means of bearings with both axial and radial support, and it is tightened axially by making use of a nut (14) at the end of said shaft; this nut being lockable by means of a slotted bevel housing at the end of the shaft, so that, when the bevel head screw (15) is tightened, radial expansion takes place at said end, which secures the fastening between the shaft threads and the nut.

15) A mechanical pedalling system according to claim 1, characterised in that, in order to optimise the relation between biomechanical and mechanical performance, the ratio between maximum and minimum relative developments has a value of 1.4±0.07, which is equivalent to a minimum angle between crank arms of 161.5°±2.5°, and the main dimensions of the system are:

| | |
|---|---|
| eccentricity of eccentric support (5): | 7.7 ± 1 mm |
| length of links (8 and 9): | 28.5 ± 2.5 mm |
| distance from bottom bracket shaft (1) to crank arm (2) | 52 ± 5 mm |
| pin (10): | |
| distance from centre (E2) to pin (10) in power plate (4): | 49 ± 5 mm |
